(19) United States
(12) Patent Application Publication
(10) Pub. No.: US 2017/0270585 A1
(43) Pub. Date: Sep. 21, 2017

(54) Method for Mitigating Perishable Product Loss

(71) Applicant: Darren Lewis, Waukegan, IL (US)

(72) Inventor: Darren Lewis, Waukegan, IL (US)

(21) Appl. No.: 15/427,969

(22) Filed: Feb. 8, 2017

Related U.S. Application Data
(60) Provisional application No. 62/294,001, filed on Feb. 11, 2016.

(51) Int. Cl. G06Q 30/06; G06Q 30/02; G06Q 40/00

(52) U.S. Cl. CPC G06Q 30/0627; G06Q 40/12; G06Q 30/0639; G06Q 30/0222; G06Q 30/0225

(57) ABSTRACT

A system and method for controlling the loss of perishable products while minimizing food investment loss. The system and method include an electronic database available via the internet and containing data related to perishable food and toiletry products including both planned and unplanned products as well as nearly expired or expired products for sale. The system and method also include a first computer used by a member retailer. The member retailer inputs data into the database regarding products for sale. A second computer is used by a customer interested in purchasing the products for sale. The second user can search by location or store type to find product for sale and can purchase the product for sale through the electronic database via the internet, thereby helping needy individuals in a community, allowing potential losses to be mitigated and sales increased by the member retailer.

### CROSS REFERENCE TO RELATED APPLICATION

This application claims the benefit of U.S. Provisional Application No. 62/294,001, filed on Feb. 11, 2016, the contents of which are incorporated by reference herein in its entirety.

### FIELD OF THE INVENTION

The invention relates generally to a system that allows grocers and restaurateurs the ability to control loss of perishable products while minimizing food investment loss in varying degrees. More specifically, the invention allows grocers/restaurateurs to store perishable items for sale in an electronic database, including both planned and unplanned as well as nearly expired or expired products, thereby allowing potential losses to be mitigated and increased sales.

### BACKGROUND FOR THE INVENTION

All food retail establishments make investments in perishable and non-perishable items. In most cases, the grocer or restaurant owner can only guess regarding the amount of food supplies that must be ordered to satisfy the demand of customers. All too often the grocer and restaurant owner err on the side of caution by ordering or preparing more than what is needed to avoid the perception of being out of stock, thereby disappointing customers and losing repeat business. Inevitably, the food that they have ordered in excess sits on the shelf beyond its expiration date or “use by” date and at the end of its useful life gets thrown away as trash and results in a lost investment.

A similar problem exists when a grocer or restaurant predicts or anticipates business at a certain level but finds that business is lower than expected. Many perishable items that have been ordered or produced on site have a very short shelf life as well as raw material cost and many labor hours involved in their production. This can also be a great cause of loss of investment for the grocer or restaurant.

A corporation as a whole faces the same issues of predicting product sales for all stores within the company and placing product orders to fulfill its needs. The corporation may utilize experienced buyers and mathematical algorithms in its attempt to place orders and control product production, but many corporations find it difficult to strike a balance between filling the store to meet the needs of customers and reducing product spoilage on the shelf. When the corporate warehouse has over ordered and product is near its expiration or “use by” date, the corporate distribution center may choose to purge or distribute the product to stores that have had past success selling those items. The corporate stores find themselves presented with the task of preventing forced out products from becoming a loss on their balance sheet; better known as shrink.

Corporations and stores have issued temporary price reductions for the purpose of selling excess inventory that undoubtedly would spoil on the store shelves without intervention. Many times intervention of this nature is unknown to the majority of customers unless you frequent a particular establishment and have knowledge of its prices. None of this would be necessary if current methods employed by these companies and stores were accurate in predicting future sales and customer needs.

While the related prior art has consisted of a variety of methods to reduce loss of investment by controlling ordering/inventory, it has proven difficult in relation to maintaining full shelf stocks. It would be advantageous to have a method which would help reduce loss of investment. It is to this need that the invention is drawn. The inventive method of this application provides an electronic method for multiple stores of various types and configurations to list perishable products that are at immediate risk of becoming lost inventory and use them to drive sales in complimentary categories by linking potential lost inventory to viable product via electronic coupons made on the website.

In summary, there are problems and shortcomings in the prior art and it is to these needs that this inventive method is drawn.

### SUMMARY OF THE INVENTION

This system and method is an improvement in a system and method of the type for controlling the loss of perishable products while minimizing food investment loss and an electronic database available via the interne and containing data, the data being information related to perishable food and toiletry products including both planned and unplanned products as well as nearly expired or expired products all products being for sale; a first computer used by a first user, the first user being a member retailer, the first user inputs data into the database regarding products for sale; and a second computer used by a second user, the second user being a customer interested in purchasing the products for sale. The second user can search by location or store type to find product for sale and can purchase the product for sale through the electronic database via the internet, thereby allowing potential losses to be mitigated and sales increased by the member retailer.

In highly preferred embodiments, all transactions occur over the internet via the centralized database. The database fosters interaction between member retailers with diverse geographic locations and customers of equally diverse geographic locations. Preferably, the member retailer is a grocer or restaurateur. It is preferred that member retailers are given the ability to compete with other member retailers to recoup their investment by selling product at a reduced price as such product would have otherwise been a monetary loss and thereby helping individuals in the member retailer's community.

Preferably, product is picked up at each member retailer's physical store location by the customer and the customer can select a pick-up time from a provided list in the database. It is also preferably that the database allows member retailers the ability to create electronic product coupons for their store with random numbers and alpha numeric characters assigned to each product coupon.

In preferred embodiments, the database allows a customer to select to search single or multiple stores using a website issued store number or using both a corporate issued store name and a store number. Preferably, the database allows the member retailer to generate reports measuring total store sales, total store refunds, net sales and website income.

It is highly preferred that the database allows customers to apply various search filters to filter search results by member retailer, product category, product name, price, tax, net price, expiration date, member retailer posting date, extreme deal products, number of days for product posting and whether a coupon is attached to a product. It is also highly preferred that the database allows customers to apply a search filter to filter products by a product category or a product subcategory. Preferably, the database allows a customer to search for a member retailer by a zip code search or by a mile-radius-input field search; both the zip code search and mile-radius-input field search results are utilized to narrow the end result of the customer's member retailer search.

This application also includes a method for assisting a member retailer which includes several steps. The steps are inputting data into an electronic database via the internet, such data related to perishable food and toiletry products including both planned and unplanned products as well as nearly expired or expired products all products being for sale; accessing the electronic database by a customer for product for sale; searching the electronic database by the customer using various search filters to narrow product search results and selecting a product for purchase; purchasing the product selected by the customer via the internet; authorizing the customer to pick up the purchased product at a member retailer's physical store location; and allowing potential losses to be mitigated and sales increased by the member retailer.

### BRIEF DESCRIPTION OF THE DRAWINGS

FIGS. 1A and 1B are overview flow diagrams illustrating the present invention;

FIG. 2A is a process flow diagram demonstrating the full functionality of the “Home” page acting as a portal that provides the user with the option to create either a customer or grocer/restaurant account;

FIG. 2B is a process flow diagram demonstrating a continuation of the home page and its diverse methods of login, time/date sensitive product searching and various aspects of viewing, purchasing and communicating with a pre-existing retail member;

FIG. 2C is a process flow diagram demonstrating the embodiment of all functions necessary for a customer to complete a purchase of time/date sensitive product and communicate with grocer/restaurateur and website operator;

FIG. 2D is a process flow diagram demonstrating the grocer/restaurateur's dashboard complete with options for accessing the product database to select and post time/date sensitive product on the embodied internet website; and

FIG. 2E illustrates a part of the aggregate process flow diagram of the present invention.

### DETAILED DESCRIPTION OF PREFERRED EMBODIMENTS

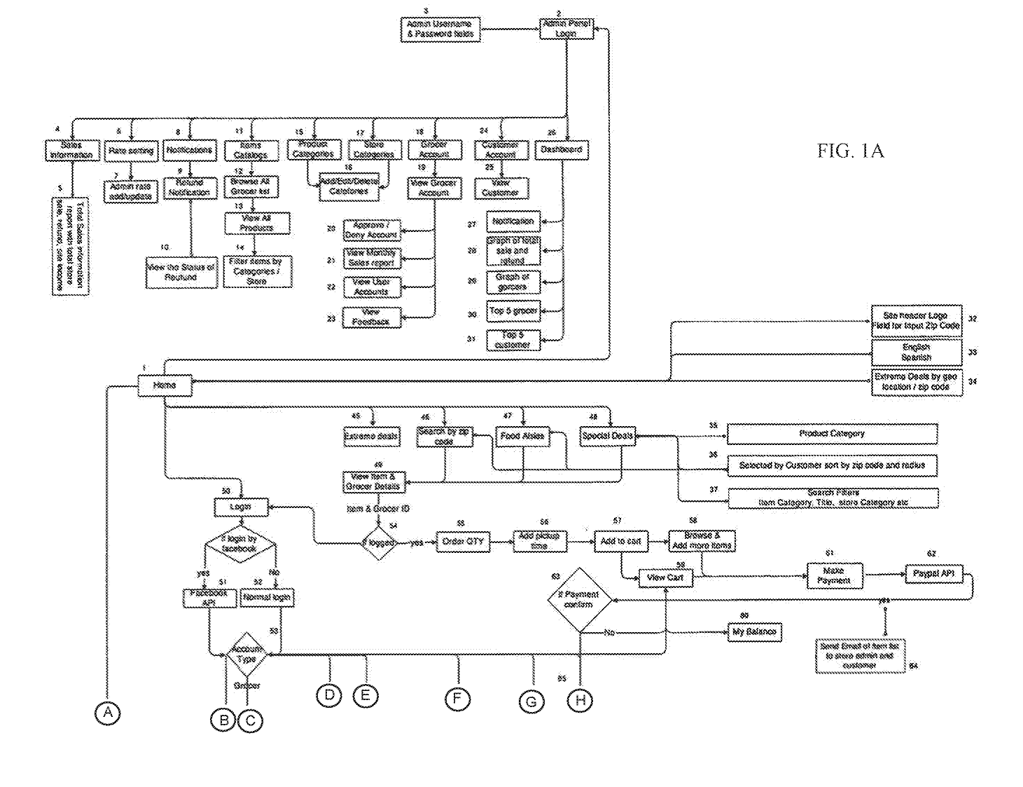

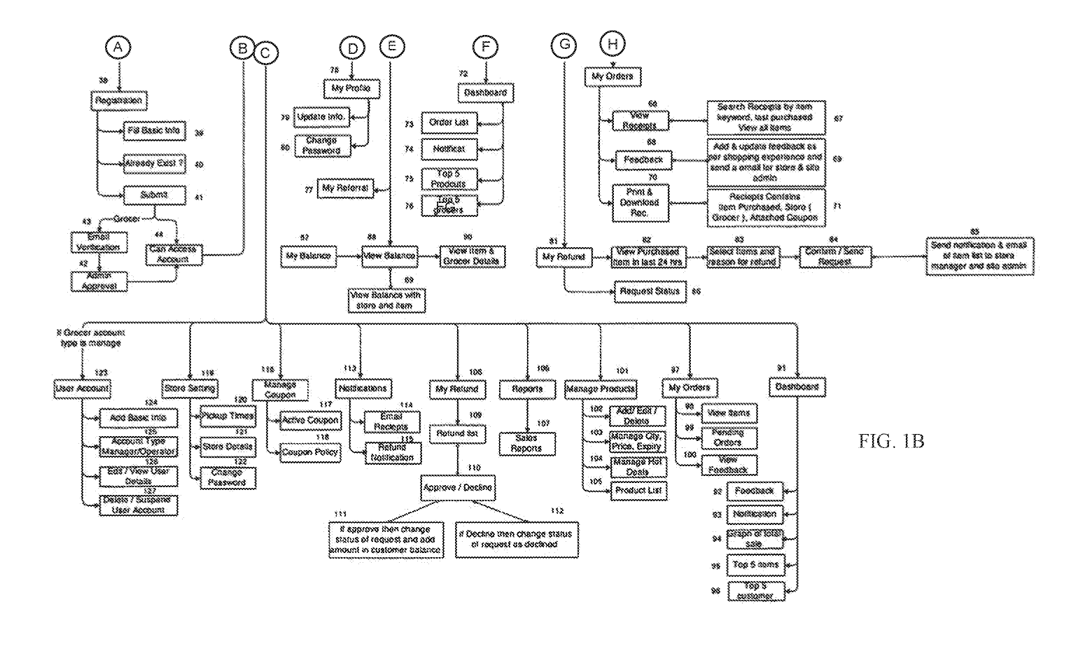

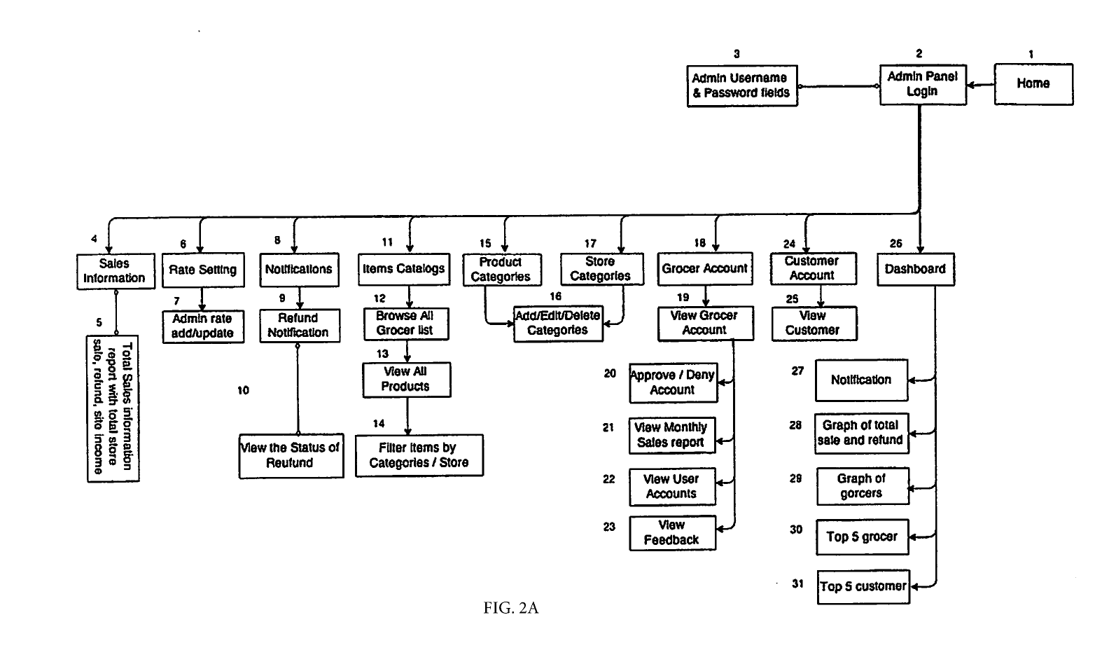

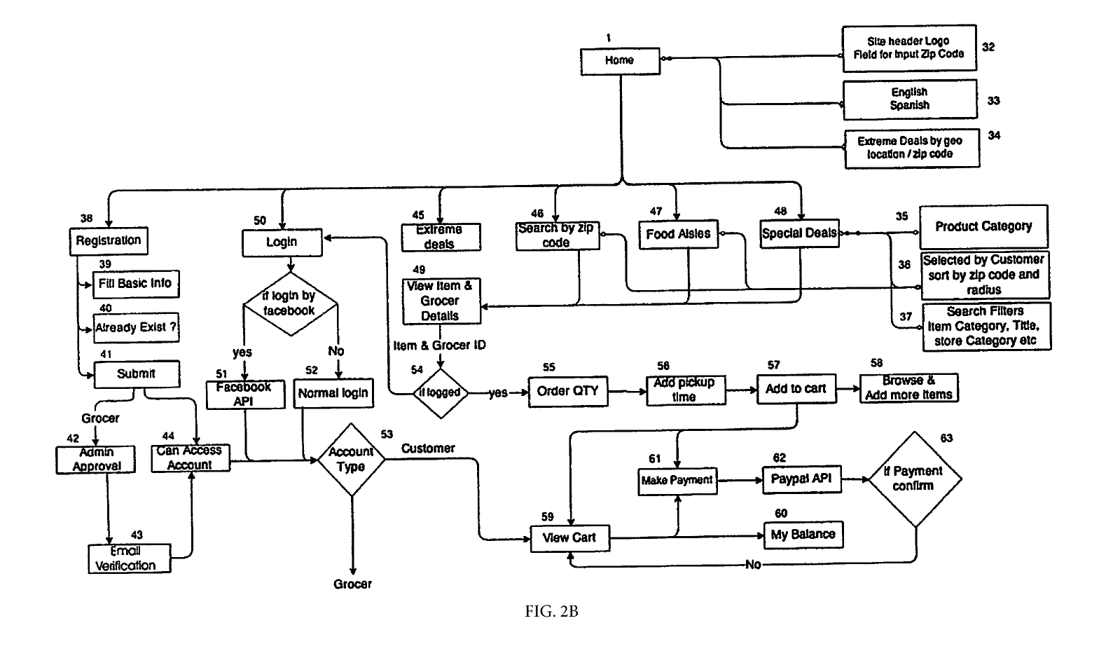

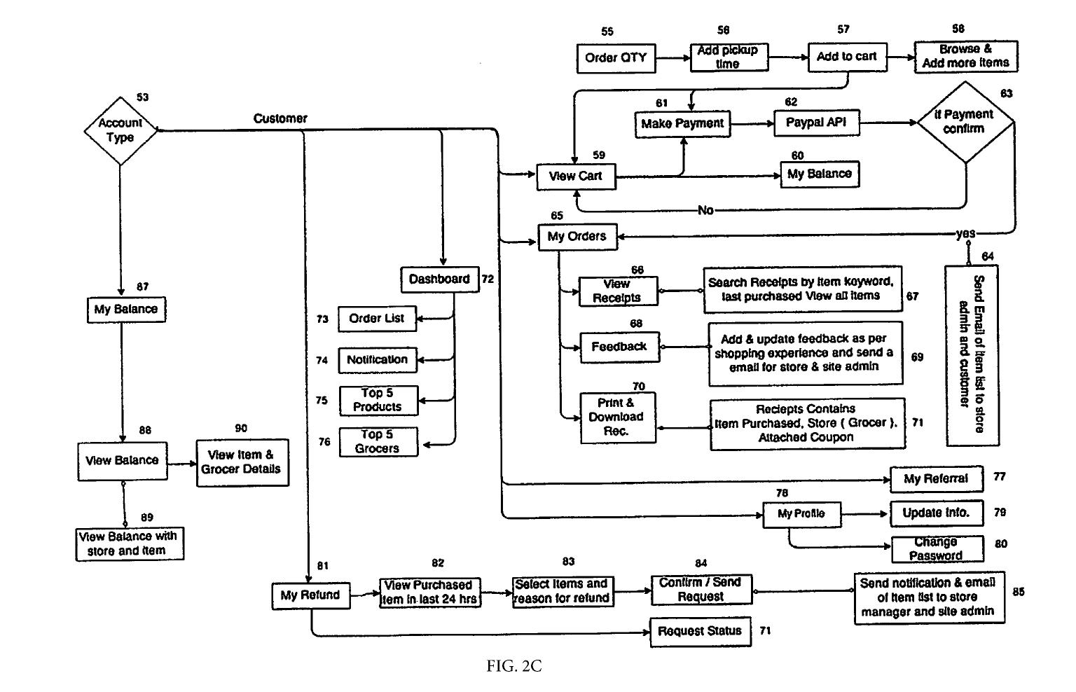

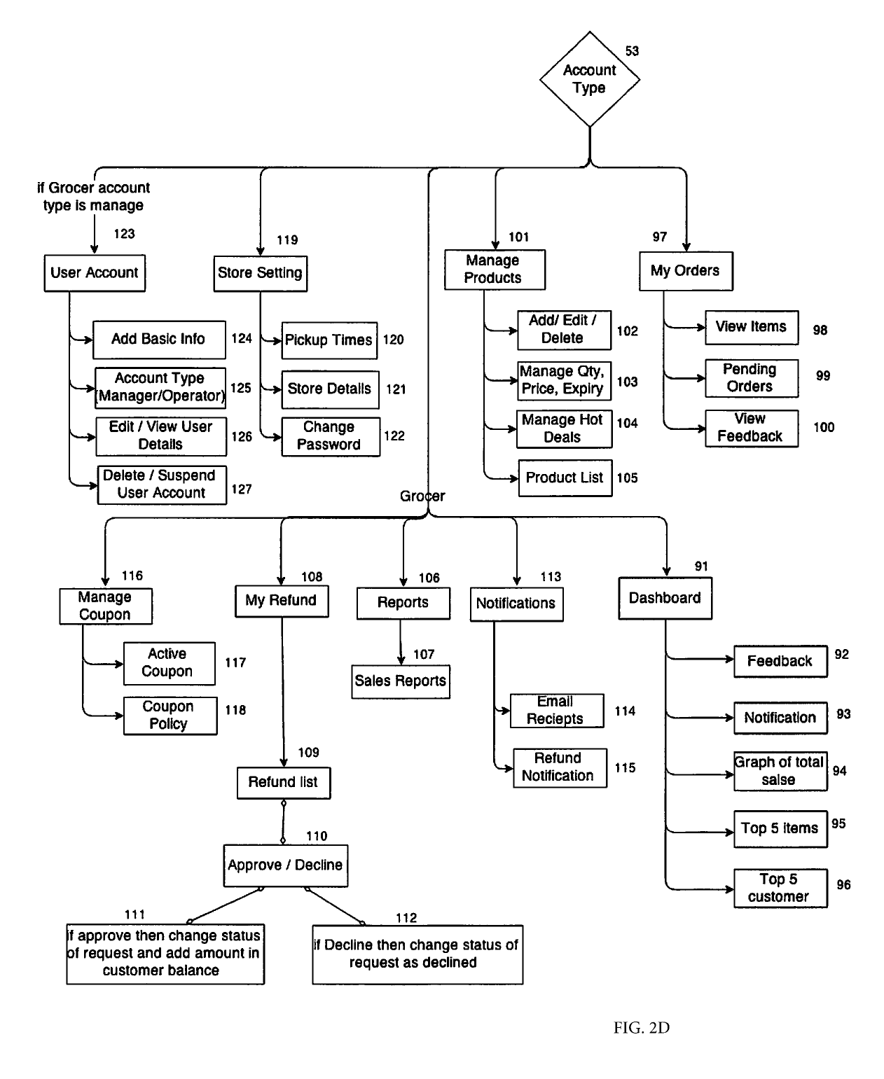

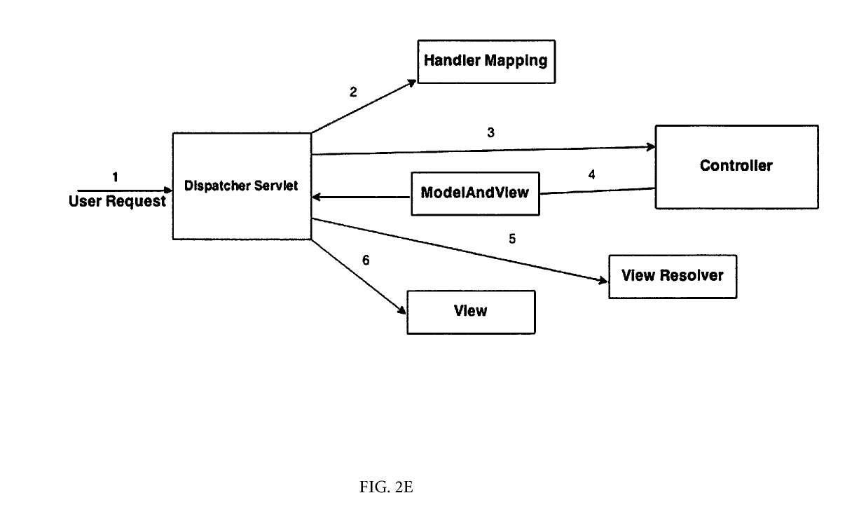

A preferred embodiment of the inventive method is shown in FIGS. 1A-2E. The description that follows includes systems, techniques, methods, and sequences referred to in FIGS. 2A-2D. FIGS. 2A-2D are process flow diagrams embodying the steps necessary to present, sell, and purchase time/date sensitive product, also known as shrink or potential loss of investment.

In the inventive method, all transactions occur over the internet via a centralized database carrying no inventories and making no deliveries but fostering interaction between pre-existing member retailers with diverse geographic locations and customers of equally diverse geographic locations. Member retailers can upload product via a computer or phone to the internet. A phone application allows member retailers to use a handheld symbol unit or their cell phone to access and upload content. The purpose of each interaction is the sale of time/date sensitive product, near or just beyond expiration, held by member retailers to customers desiring said product. Local member retailers are given the ability to compete with other online retail organizations, recoup their investment by selling product that would have been a loss and help the needy in their community. Although purchases occur over the internet, product is picked up at each member retailer's physical location.

The inventive process allows stores an opportunity to recover product investment dollars that once were lost. Product once considered waste is used to recover a store's initial investment. The inventive method allows product providers the ability to create accounts as needed for single or multiple stores and list items for sale.

The inventive method affords product providers the ability to create electronic coupons for their store with random numbers and alpha numeric characters. Product providers have the ability to electronically tie a coupon to a specific complimentary product for the purpose of advancing sales in the coupon's given category by the use of a product once considered. The coupons are printable. When such a coupon is taken into the store the coupon is voided out electronically on the site to eliminate coupon fraud. While currently all coupons, both printed and electronic, must be scanned in-store, the inventive method also allows the importation of manufacturer's electronic coupons that can be used to reduce the cost of, or pay for, listed items on our online website.

FIGS. 1A and 1B are overview flow diagrams illustrating the steps of the inventive method in the database. FIGS. 2A-2E detail the inventive database and method shown in FIGS. 1A and 1B in more detail. Each number (shown as blocks 1-115) on the drawings represents a separate step or option for the user in the inventive database and each block (numbered 1-115) is described herein. Each block (such blocks are the various rectangles in each figure) represents a different screen or page in the computer database. The terms “block,” “page” and “screen are used interchangeably in this application and are meant to indicate the same thing. The directional arrows on each figure represent the order of different screens and how they are related in the computer database.

FIGS. 1A and 1B are process flow diagrams. Block 1 represents the home page which comprises all functions necessary to complete all operations and transactions related to the entire embodiment. The aforementioned customer or grocer/restaurant account is the impetus for all future site transactions. Also provided is a portal for the site administrator to access all functions regulating all site transactions.

Block 2 in FIG. 2A, designated as “Admin. Panel Login,” is the entry portal utilized by the Site Administrator to access all functions necessary to control all rules governing site operations. FIG. 2A also illustrates block 3 the Administrator Username and Password fields which represents data/input fields created by the site designers/programmers culminating in a site login area (shown as block 2) for the Site Administrator that requests a pre-established and programmed username and password.

Block 4 in FIG. 2A is the embodiment of the sales information page displaying sales data captured as the end result of product sales and can be measured in various currencies. Database inquiries are made by inputting numeric date parameter values in provided “from” and “to” fields or selecting date parameters via pop-up calendar. Single or multiple stores can be selected using website issued store numbers or corporate issued store name and store numbers. The “submit” or “reset” buttons must be selected to initiate all requests. Block 5 embodies reports measuring “total store sales,” “total store refunds” to provide “net sales” and website income. Block 6 embodies the complete page element encompassing the Administrative percentage rate and Extreme Deals upper monetary limit.

In FIG. 2A, the process flow diagram block that is the embodiment of page elements displaying data fields in which the desired website transaction fee known as the “Administrative Rate” is inputted or updated is block 7. “Extreme Deals” is feature shown in block 45 located on the home page, where the upper pricing limit is input or updated. Both rates are unilateral across the entire site. Extreme deals are assigned to a store and geographic area by zip code. The submit or reset buttons must be selected to process all request. Other product condition descriptions can also be added to product content uploaded by a member retailer such as the following (but not limited to) “ripe,” “good for recipes,” “slightly dented” or “dented,” etc.

Block 8 is the embodiment of a page that details all system data notifications. Each individual sale, refund, customer comment and registration request is chronicled in one location. Block 9 is the embodiment of a page element refund notification is an extension of block 8. Block 10 is the embodiment of the page that allows for status updates detailing when refunds are requested by customers and processed by stores as “approved” or “denied”.

In FIG. 2A, block 11 is the embodiment of the “Items or Store Catalog” page where grocer/restaurateur information gathered at registration and product management information can be selected and displayed. Block 12 is the embodiment of a page element by which the “Items or Store Catalog” data contained in the website database details the store number, owner's name, store name, store type or category, total number of products listed for sale under an individual store name and number, and a product information display button denoted by an italicized “I”. Block 13 is the embodiment of the selection of a product category. This produces a visual product display of all items offered.

Block 14 is a page functional aspect that is the embodiment of a filter displaying store, category, item name, price, tax, net price, expiration date, posting date, ability to select product as an extreme deal, number of days for product posting and whether or not a coupon is attached to the sale item.

Block 15 is the embodiment of the main product categories; meat, dairy, produce, bakery, deli, frozen, baking and cooking needs, beverages, condiments and sauces, laundry, paper & cleaning, etc. Categories and subcategories can be grouped using a search field. Also detailed are the subcategories, such as types of meat under the meat category, for example, chicken, turkey, beef, pork, etc. All subcategories are a detailed extension of their parent category.

Block 16 is the embodiment of a page that product and/or store type categories and or subcategories can be added, edited or deleted. Block 17 is the embodiment of the main store categories, for example, super store, convenience store, grocery stores, restaurants, etc.

In FIG. 2A, block 18 embodies the Grocer Account/Store Account page which displays basic information for all grocers divided into three categories: sort number, owner/manager, store name and information button for viewing by selection. Block 19 is the embodiment of a page displaying new grocer/restauranteur accounts detailing owner/manager, store type, address and contact information.

Block 20 is the page element (for grocer/restauranteur accounts) which must be viewed by the site administrator to approve or deny grocer accounts before they can be listed with products on the website. Displayed information is organized by store number, store name and owner/user. An information display button denoted by an italicized “I” is present. Block 21 is the embodiment of a page element that allows the administrator to view the monthly sales report for all grocers/restauranteurs. Block 22 is the embodiment of a page element that allows viewing all user accounts via the selection of the information display button, thereby producing the owner's name, store name, physical address, phone number and email address. Included is an edit function for the correction of any altered information.

Block 23 is the embodiment of a page element that provides the administrator a view of grocer/restauranteur account customer feedback with a listing of the customer opinion by selection of a certain number of rating stars between 1 and 5.

Block 24 is the embodiment a page by which the administrator has the ability to view all customer accounts. Block 25 is the embodiment of a page element displaying customer accounts, which are organized by customer name and an information display button denoted by an italicized “I”. When selecting the “I” the customer's name address, phone number and email address are displayed. Also, each order placed through the system is displayed by an assigned number along with another information display button which can be selected to display a detailed receipt detailing the purchases of individual items.

FIG. 2A illustrates block 26 which is the embodiment of a page displaying the administrative dashboard which provides a condensed view of all notifications, graphs of grocer sales, the top five grocers, a graph of refunds and the top five customers. Block 27 is the embodiment of a page element displaying notifications providing customer feedback via survey, purchases and refund information. Block 28 is the embodiment of a page element displaying a graph of total sales and refunds gathered in the previous six months. Block 29 is the embodiment of a page element displaying a graph with the total number of newly registered grocers in the previous six months.

Block 30 is the embodiment of a page element displaying a table with the name and total sales of the five best selling grocers operating on the site by revenue. Block 31 is the embodiment of a page element displaying a table with the names of the top five customers with an information display button that details their names, address, phone number, email address and their detailed purchases.

FIG. 2B is a process flow diagram demonstrating a continuation of the home page (Block 1 can be seen at the top of the figure) and its diverse methods of login, time/date sensitive product searching and various aspects of viewing, purchasing and communicating with a pre-existing retail member.

Specifically, in FIG. 2B block 32 is the embodiment of a page with the site logo and a field for inputting the zip code as a product search parameter. Block 33 is the embodiment of a page with the incorporated language translation program. Block 34 is the embodiment of a page with an input field for the geo-location zip code search parameter for the Extreme Deals area.

In FIG. 2B, block 35 is the embodiment of a page with product category input programming functions. The function program is designed to contain, categorize and sort all items stored in the product database. The product category selection field containing the major product descriptions is utilized to make specific the user's product selection. Block 36 is the embodiment of a page with zip code and mile radius input programming functions. The zip code field 46 can be linked to various mapping systems. The mile radius input selection field is pre-populated with varied radial choices based upon the fixed center of the input zip code. Both are utilized to narrow or make more specific the end result of the user's product search.

Block 37 is the embodiment of page programming functions designed to arrive at specific product types. The page contains complete sorting fields; zip code, store categories, product categories and mile radius. All categories are pre-determined and input by the website administrator. Each store type has been created based upon the product types carried by a store.

Block 38 in FIG. 2B is the embodiment of the page with the customer and grocer/restaurateur registration portal containing input fields for full name, store name and number, position, address, phone number, address, picture/image file upload, and email address. Selecting either customer or grocer/restaurant will differentiate between the store name and number and position fields being added for input.

Block 39 is the embodiment of a page element with a registration portal information input fields for name, store name and number, position, address, phone number and image and submission of said information for processing and cross-referencing with the database. Block 40 is the embodiment of the page element utilized to verify the basic information; name, address, phone number and email address plus store name and number, and position for grocers/restaurateurs. The information is submitted, processed and cross-referenced with the database.

FIG. 2B illustrates that block 41 is the embodiment of a page element that responds to submitted information with either approval for customer accounts or, if the submitted information already exists, rejection with improper information being highlighted for review and correction. Block 42 is the embodiment of a page element where submitted grocer/restaurateur applications and email address information are held inactive until reviewed for approval by the website administrator. Block 43 is the embodiment of a page providing an emailed account confirmation letter detailing the new user identification (“ID”) and password. All user IDs are identical to the submitted email address but the initial password is a random generation by the database. Block 44 is the embodiment of a page element that allows users to access a new account once verified.

Block 45 is the embodiment of a page element displaying all Extreme Deals located on the website home page and is a culmination of products selected by individual stores that comply with pricing limits established by the website administrator as seen in FIG. 2B. Block 46 is the embodiment of a zip code input field to be utilized in the process of narrowing the end result of the product search field. The zip code input field is linked to the zip code and mile radius programming functions 36.

Block 47 in FIG. 2B is the embodiment of a pre-populated store category and/or product category selection fields input by the site administrator. The store category and/or product category fields are linked to the database/programming function (block 37) to display multiple items according to product type and store type for block “Food Aisles”.

FIG. 2B illustrates that block 48 is the embodiment of a page displaying “sale” items that are pre-populated with product selected by the grocer/restauranteur for each store. The product category field is linked to the product category data base/programming function shown in block 35.

Block 49 is the embodiment of a page working with product search functions to display end resulting product or products with complete details.

Block 50 displays the login portal with login ID field and password field that will access both the customer and grocer/restauranteur database. Block 51 is the embodiment of the Facebook® Application Protocol Interface (“API”) which allows users to login to accounts by logging into their Facebook® accounts. The API will allow a cross referencing of account users information before allowing login. Block 52 is the embodiment of a page element allowing direct login by accessing the website using a login ID and password.

FIG. 2B illustrates that block 53 is the embodiment of a page element with the website accessing the database matching the provided login ID and password or Facebook® API to verify account type, customer or grocer/restauranteur, and provide access to the proper database.

Block 54 requires customers to log into the website before being allowed to make a purchase. If not logged in the customer receives a message and is redirected to the login portal.

Block 55 is the embodiment of a page element representing the order quantity field in which customers will enter the quantity of product that they wish to purchase. The field is linked to the product database and will subtract from the total quantity of the available product. Block 56 is the embodiment of a page element representing a product pick-up time field. The field is pre-populated with times selected by the store owner or user during registration. Customers select a pick-up time from the provided list.

Block 57 is the embodiment of a page element providing “add to cart” functionality. When viewing multiple products or a single product, each item will have its own “add to cart” field where a number/quantity can be input. A corresponding “add to cart” button will be located directly under the quantity field and selected in order to update the universal cart with the desired quantity.

FIG. 2B illustrates that block 58 is the embodiment of the site's continuous shopping feature, allowing uninterrupted shopping while updating the universal shopping cart with items to be purchased.

In FIG. 2B, blocks 59-63 illustrate the payment process. Block 59 is the embodiment of a page displaying a view of the shopping cart which can be accessed directly from the home screen before or after login and at any time while shopping. The shopping cart is capable of storing multiple items and displays the requested quantity of each item. Items can be added to or subtracted from while viewing the shopping cart. Block 60 is the embodiment of the page element displaying a customer account balance accounting system. The account balance system information accessed from the database contains information relating to monies from refunds and can be used toward additional purchases on the website.

Block 61 is the embodiment of a page element displaying the payment system which accesses the monetary balance of all items selected for purchase in the shopping cart database, allows for customer account credits to be applied to the balance, and then receives the remaining balance via the PayPal API. Payment must be made by completing the card number, card type, expiry month, expiry year, first name and last name, which is then processed through the PayPal® API. Any available balances can be used toward purchases.

Block 62 is the embodiment of the PayPal® API that is utilized to access payments from customer credit, debit and bank accounts across various institutions. Block 63 is the embodiment of the PayPal® API relaying information and payment or denial to the website database. If payment has not been made the program will return the customer to view the cart block 59. If payment has been made the programming will move to block 64.

FIG. 2C illustrates all functions necessary for a customer to complete a purchase of time/date sensitive product and communicate with grocer/restaurateur and website operator.

In FIG. 2C, block 64 is the embodiment of the functional database acknowledging customer payment by sending an email to the store, site administrator and the customer providing complete order details.

Block 65 is the embodiment of the “My Orders” page providing customer access to each order's details that has been placed and paid for monetarily. Block 66 is the embodiment of a page element providing access to “View Receipts”.

FIG. 2C illustrates that block 67 is the embodiment of a function providing the choice of viewing key essential information such as searching receipts by item keyword, last purchased and or viewing all items. Block 68 is the page element embodiment for customers to provide feedback. Block 69 is the functional embodiment of adding and updating customer feedback by shopping experience which is sent to each customer and the administrator. Block 70 is the embodiment of a page element with a basic print and download sequence linked to “View Receipts” in block 66. Block 71 is the embodiment of a page providing receipt details; total items purchased, store number, grocer and attached coupon and values.

Block 72 is the embodiment of a page displaying the customer dashboard with access to multiple points of information for the customer as seen in FIG. 2C. Block 73 is the embodiment of a page element displaying the customer's product order list, the order number, the status of the order and the total cost of each order. Block 74 is the embodiment of a page element which displays notifications providing refund status of pending or completed orders. Correspondence can be delivered between the stores, the site administrator and the customer concerning all matters. Block 75 is the embodiment of a page element displaying a list of the top five products that have been purchased, considering all stores within a geo-zip code region. Block 76 is the embodiment of a page element displaying a list containing the top five grocers with a geographic-zip code region based upon rating provided from customer feedback.

In FIG. 2C, block 77 is the embodiment of a page displaying a referral system in which new registrants input those who have referred them to the website for possible future reward. Block 78 is the embodiment of a page displaying a customer profile this is a portion of the database that contains all customer information such as name, address, phone number, email address and photo. The photo can be uploaded from any selected file in the system in use or via the internet. Block 79 is the embodiment of a page displaying the edit function of the customer profile program designed to change personal information. Selecting the edit field allows one to edit the customer's name, address, phone number, email address and photo. Block 80 is the embodiment of a page displaying the edit function of the customer profile program designed to change a password. The current password, the new password and the confirmation of the new password must be input correctly before a change is recorded.

In FIG. 2C block 81 is the embodiment of the refund function programming through which customers can request refunds within a twenty-four hour period of scheduled purchase pick-up. Block 82 is the embodiment of page element programming which tracks all purchases for a period of twenty-four hours. The measurement is to correspond with the website refund policy.

Block 83 is the embodiment of page element programming that allows the selection of individual items for refund and follows the rules of the refund policy. Said policy dictates that customers select one of two qualifying reasons for a refund. Block 84 is the embodiment of page element programming that asks for the customer to review and confirm the item and amount of the refund request before forwarding said request. Block 85 is the embodiment of page with programming that sends notification of the refund request to both the manager of the store where the questioned product was purchased and the site administrator.

FIG. 2C illustrates that block 86 is the embodiment of a page element accessing refund request status programming. The programming relays to the customer and site administrator all decisions made by the store manager. Block 87 is the embodiment of the page through which customers view account balances resulting from refunds. Block 88 is the page element by which the balance is viewed once selected by the customer. Block 89 is the embodiment of programming functionality with respect to the account's monetary balance. The store's identification and product/item is processed and posted as a refund in the View Balance area.

FIG. 2D is a process flow diagram demonstrating the grocer/restaurateur's dashboard complete with options for accessing the product database to select and post time/date sensitive product on the embodied internet website.

In FIG. 2D, block 90 is the embodiment of a view of a page displaying all refunded items and accompanying grocer details. Also demonstrated are functions allowing the grocer/restaurateur to act upon all information and data necessary to conduct and complete transactions reducing time/date sensitive product. Block 91 is the embodiment of a page displaying the initial view of the grocer/restaurateur dashboard. Block 92 is the embodiment of grocer/restauranteur feedback page elements residing within the dashboard. Block 93 is the embodiment of the grocer's notification system page element in which information concerning refund requests and administrator information are relayed.

Block 94 is the embodiment of a grocer home page elemental graph that displays the total sales of the store and the total returns as calculated by the database. Block 95 is the embodiment of a page element chart displaying the top five items sold for a single store. Block 96 is the embodiment of a page element chart displaying the top five customers by purchase for a single store.

In FIG. 2D, block 97 is the embodiment of “My Orders.” It is the grocer page on which each of the grocer's orders are displayed with various delivery details. Block 98 is the embodiment of a page element displaying the “View Items” details button represented by the letter “I”. Once selected, a unique receipt number, the items purchased, the quantity, price and the unique store generated coupon are shown. Search functions to find particular items are available for website/store made coupons, and an “Order Complete” button is present for the grocer to select once all items have been filled. Block 99 is the embodiment of “Pending Orders” page or those which have not been completed. Block 100 is the embodiment of the grocer's page displaying “Feedback” which is comprised of comments from all customers and communication from the administrator.

FIG. 2D illustrates that block 101 is the embodiment of the product management page that accesses the website database for images and information that can be combined with user input and uploaded to provide information to customers about short-dated, out of date or excessive quantities of products available for purchase.

Block 102 is the embodiment of the Add, Edit and Delete page with functions. The “Add More” button allows the grocer/restauranteur access to the UPC, description, category, sub-category, unit, unit price, coupon title, coupon detail, extreme deal, and number of days to be displayed input fields. Each product has an edit button, represented by a pencil, attached to the product. Once selected, the previous product information that was input to the database is retrieved for editing. The delete function is located next to the edit button for the purpose of removing product that has been previously uploaded for sale. Block 103 is the embodiment of the database function that allows for managing quantities, the price and expiry of all products within the website database. Each input field requires a numerical value that conforms to a structured pre-determined format.

In FIG. 2D block 104 is the embodiment of a page with a selection field that allows the grocer/restauranteur to elect an item as an extreme deal. The election must coincide with the parameters set forth by the website administrator concerning pricing limits of said items. Block 105 is the embodiment a page with a product list which is created after all fields outlined in block 103 are completed. The product list displays the store number, UPC, product image and product name, a product search field and an edit button.

Block 106 is the embodiment of the “Reports” page that provides access to additional functional elements. Block 107 is the embodiment of a page element displaying the calculations of sales and refund information over a six month period. Block 108 is the embodiment of the “My Refunds” page that provides access to additional functional elements. Block 109 is, the page element embodiment of the “Refund List” that displays the customer's name, order number, product, quantity, reason for the refund, net price and action taken. Block 110 is the functional embodiment of the “Approval or Denial” process. The grocer/restauranteur is given an option of approval or denial of a particular refund request.

FIG. 2D shows that block 111 is the functional embodiment of the approval process where the grocer/restauranteur selects the “approve” option. At this time the functional program interacting with the database will change the status of the request and credit the refunded amount to the customer's balance.

Block 112 is the functional embodiment of the request denial process where the grocer/restauranteur selects the “decline” option. At this time the functional program interacting with the database will change the status of the request. Block 113 is the embodiment of the Notification page which acts as a conduit for payment and refund request communication. Block 114 is the embodiment of a page element delivering email notifications of monies received from purchases. Block 115 is the embodiment of a page element delivering refund notifications. Block 116 is the embodiment of the “Manage Coupon” page/screen providing access to coupon creation and management.

FIG. 2D illustrates block 117 which is the embodiment of a page element dedicated to new complimentary product coupon creation. Said page consist of an “Add More” button, a search field, store number, title, image, item edit and cancel button. The “Add More” button is used to access the product input screen. New in-store coupons are created by completing the Coupon Title, Coupon Description, UPC Code, Product Name, Start and End dates and a browse button to access images on a computer or phone to upload to the website. Inputting a UPC coded will automatically generate the description and item image. If the UPC code is not listed, all fields can be manually input, a picture taken and uploaded to the site. The “submit” button completes the uploading process. Coupons are attached to the customer receipt and each is given a unique system-generated serial number. Once redeemed, the grocers/restaurateurs must access the receipt and mark the receipt as redeemed.

Block 118 is the embodiment of a page element acting upon coupon policy that states items already listed by a store on the website cannot be used to create a coupon. Coupons can be used only once and coupons cannot be transferred. Block 119 is the embodiment of the store setting page which allows access to store details such as password updates, store details and pick-up time settings. Block 120 is the embodiment of a page element with store pick-up times settings which allows the store manager to select multiple one hour increment windows of time in which customers may pick up items that have been ordered via the website.

Block 121 is the embodiment of a page element allowing input and editing of details such as the owner's name, position, store address, store type, store number, email address, and contact phone number. Block 122 is the embodiment of a page making it possible to change a grocer/restauranteur password by entering the old password, the new password and a confirmation of the new password. Block 123 is the embodiment of the User Account page which contains elements that the grocer/restauranteur uses to create and manage user profiles. Accessing information input fields is accomplished by using the “add more” button embedded in the page. Block 124 is the embodiment of an element which adds user information that consists of store number, user name, job/role, and email ID.

FIG. 2D shows that block 125 is the embodiment of an element that allows the store administrator to select the user's status and rights by selecting from a pre-populated field to define a user as a manager or user/operator. Block 126 is the embodiment of a page element that allows the grocer to view and edit all user and manager accounts. Block 127 is the embodiment of a page element that allows the grocer to suspend or delete user and manager accounts.

FIG. 2E illustrates a part of the aggregate process flow diagram of the present invention. FIG. 2E illustrates that a request from the user, (arrow 1 in FIG. 2E), arrives in a single servlet, Dispatcher Servlet. This pattern exists in Model View Controller framework designated as a front controller where a single servlet is responsible for receiving a request while delegating and processing to other components of the application and returning a response to the user. Once the Dispatcher Servlet receives a request it must decide the controller to which the request will be sent. Therefore it queries the Handler Mapping, (arrow 2 of FIG. 2E). Based on the request, the URL Handler Mapping finds the controller. The request is then sent to the Controller, (arrow 3 of FIG. 2E), that will process the request using the data contained therein. Once the Controller receives the request, it processes the data and performs operations utilizing the business rules of the application.

A rendering by the logic Controller results in information that is taken back to the user (the model). The information is then formatted in a way that the user can understand and the Controller sends it for viewing. The model and view are encapsulated in a Model and View object, (arrow 4 of FIG. 2E), and returned to the Dispatcher. As the Controller does not lend itself to just one view it sends a “hint” in the Model and View object to the Dispatcher for clarification concerning which view will disseminate the data. The Dispatcher passes this hint to the View Resolver, (arrow 5 in FIG. 2E), and returns the view which should be displayed. Finally, the Dispatcher sends the information (model) to the View Java Spring Programming (JSP page) (arrow 6 in FIG. 2E). The page renders the information received and it is returned to the user.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A system for controlling the loss of perishable products while minimizing food investment loss, comprising:
an electronic database available via the internet and containing data, the data being information related to perishable food and toiletry products including both planned and unplanned products as well as nearly expired or expired products all products being for sale;
a first computer used by a first user, the first user being a member retailer, the first user inputs data into the database regarding products for sale; and
a second computer used by a second user, the second user being a customer interested in purchasing the products for sale;
wherein the second user can search by location or store type to find product for sale and can purchase the product for sale through the electronic database via the internet, thereby allowing potential losses to be mitigated and sales increased by the member retailer.

2. The system of claim 1 wherein all transactions occur over the internet via the centralized database, the database fostering interaction between member retailers with diverse geographic locations and customers of equally diverse geographic locations.

3. The system of claim 1 wherein the member retailer is a grocer or restaurateur.

4. The system of claim 1 wherein member retailers are given the ability to compete with other member retailers to recoup their investment by selling product at a reduced price as such product would have otherwise been a monetary loss and thereby helping individuals in the member retailer's community.

5. The system of claim 1 wherein product is picked up at each member retailer's physical store location by the customer and the customer can select a pick-up time from a provided list in the database.

6. The system of claim 1 wherein the database allows member retailers the ability to create electronic product coupons for their store with random numbers and alpha numeric characters assigned to each product coupon.

7. The system of claim 1 wherein the database allows a customer to select to search single or multiple stores using a website issued store number or using both a corporate issued store name and a store number.

8. The system of claim 1 wherein the database allows the member retailer to generate reports measuring total store sales, total store refunds, net sales and website income.

9. The system of claim 1 wherein the database allows customers to apply various search filters to filter search results by member retailer, product category, product name, price, tax, net price, expiration date, member retailer posting date, extreme deal products, number of days for product posting and whether a coupon is attached to a product.

10. The system of claim 1 wherein the database allows customers to apply a search filter to filter products by a product category or a product subcategory.

11. The system of claim 1 wherein the database allows a customer to search for a member retailer by a zip code search or by a mile-radius-input field search; both the zip code search and mile-radius-input field search results are utilized to narrow the end result of the customer's member retailer search.

12. A method for assisting a member retailer comprising the steps of:
inputting data into an electronic database via the internet, such data related to perishable food and toiletry products including both planned and unplanned products as well as nearly expired or expired products all products being for sale;
accessing the electronic database by a customer for product for sale;
searching the electronic database by the customer using various search filters to narrow product search results and selecting a product for purchase;
purchasing the product selected by the customer via the internet;
authorizing the customer to pick up the purchased product at a member retailer's physical store location; and
allowing potential losses to be mitigated and sales increased by the member retailer.

13. The method of claim 12 wherein the inputting step allows member retailers to compete with other member retailers to recoup their investment by selling product at a reduced price as such product would have otherwise been a monetary loss and thereby helping individuals in the member retailer's community.

14. The method of claim 12 wherein the purchasing step further includes the customer selecting a pick-up time from a provided list in the database.

15. The method of claim 12 wherein the inputting step further includes allowing the member retailers the ability to create electronic product coupons for their store with random numbers and alpha numeric characters assigned to each product coupon.

16. The method of claim 12 wherein the searching step further includes allowing a customer to select to search single or multiple stores using a website issued store number or using both a corporate issued store name and a store number.

17. The method of claim 12 further including the step of allowing the member retailer to generate reports measuring total store sales, total store refunds, net sales and website income.

18. The method of claim 12 wherein the searching step further includes allowing customers to apply various search filters to filter search results by member retailer, product category, product name, price, tax, net price, expiration date, member retailer posting date, extreme deal products, number of days for product posting and whether a coupon is attached to a product.

19. The method of claim 12 wherein the searching step further includes allowing a customer to search for a member retailer by a zip code search or by a mile-radius-input field search; both the zip code search and mile-radius-input field search results are utilized to narrow the end result of the customer's member retailer search.
